(19) United States
(12) Patent Application Publication
(10) Pub. No.: US 2012/0068032 A1
(43) Pub. Date: Mar. 22, 2012

(54) Metal Hooked Utility Bracket Assembly

(76) Inventor: Debra Stockman, Noble, OK (US)

(21) Appl. No.: 13/204,695

(22) Filed: Aug. 7, 2011

Related U.S. Application Data
(60) Provisional application No. 61/372,165, filed on Aug. 10, 2010.

(51) Int. Cl. F16M 13/02; F16B 45/00

(52) U.S. Cl. 248/225.21

(57) ABSTRACT

A metal hooked utility bracket assembly which includes a plurality of metal hooks for removably mounting the bracket assembly over, onto and around a vertically-oriented unobstructed structure of corresponding depth, width and height. A number of metal horizontal cross member(s) are permanently attached to the attachment hooks perpendicularly; the cross member(s) are in between the attachment hooks and the utility hook(s) and/or basket(s). A number of common metal hook(s) and/or basket(s) or any combination thereof are permanently attached to the horizontal cross member(s), on the side opposite the attachment hooks, for the purpose of receiving items. It also includes resilient element(s) which can be removably attached onto the ends of the attachment hooks to prevent the bracket assembly from being accidentally dislodged when mounted, if the user desires.

### CROSS-REFERENCE TO RELATED APPLICATIONS

This application claims the benefit of U.S. Provisional Application No. 61/372,165, filed Aug. 10, 2010.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention is in the technical field of utility hooks.

More particularly, the present invention is in the technical field of metal utility hook bracket assembly.

Wire and modular shelving is increasingly used in households across the United States and the World. Such shelving can be free-standing, such as ‘baker's racks’ as well as many other varied types of consumer-assembled or pre-assembled units for use in widely varied residential, commercial and industrial applications and sold in many major retail and/or home stores under many trade names, or they can be mounted to a wall, such as the wire shelving manufactured by the Closetmaid© Corporation or other similar units and often found in closets, laundry rooms, pantries, storage rooms and the like. They are even sometimes used in bedrooms, living rooms, other rooms or even outdoors. These shelving units provide useful storage space for many consumers in many varied residential, commercial and industrial situations; however the frontal face of the above referenced units usually goes unused.

The very use of such shelving units indicates that the user is desirous of making functional use of their space and all persons have a need to conveniently hang or store items at one time or another. This is often especially useful in areas where one would frequently use this type of modular shelving such as laundry rooms, pantries, storage rooms and kitchens.

Double-sided “J-hooks” have long made use of a similar area on specialized, commercial, steel blade-type pot and pan hangers which are generally mounted from the ceiling. They attach securely and yet are easily removable and repositionable. However the opposing hooks makes one hook awkward to use, especially if not being hung from a ceiling mounted unit, as the user must reach past any front objects to retrieve an item from the back hook. Single hook units are also not very functional when being used to store a multitude of objects.

Wall mounted bracket assemblies cannot be readily repositioned.

### SUMMARY OF THE INVENTION

It is an object of this invention to provide flexible and useful utility bracket assemblies of hook(s) and/or basket(s), positioned and repositionable anywhere the user finds a shelf or other unobstructed vertical structure of corresponding and unobstructed depth, width and height to quickly and easily attach it to.

The present invention is a hooked metal wire utility bracket assembly designed for users to be able to securely yet removably mount the bracket assembly onto the vertical face of free-standing shelving units or other shelving or bars, usually made of wire, by either placing it over the top bar and a secondary bar, or so it is supported on a solid wall or face of some other structure of corresponding depth and width. It is mounted to a vertical, outward facing support, shelf or surface, of a wall-mounted variety or as part of a free-standing unit, by means of supporting hooks which fit downwardly into place over, onto and around said structure and remain mounted due to gravity. The bracket assembly will include cross member(s) set horizontally perpendicular to the attachment hooks as well as common hook(s) and/or basket(s), or some combination thereof on the side opposite the attachment hooks.

It may secured by means of flexible, resilient keeper element(s) placed onto the ends of the attachment hooks and which shall be made of rubber or a similar substance allowing flexibility and a fit which shall grasp the wire prongs firmly and hold the bracket assembly from being accidentally dislodged when mounted. It could also be used without the keeper(s) in the event the user is unable or unwilling to use them.

It is normally produced in a scale which facilitates use by consumers for personal-sized items however it may be produced so as to accommodate larger or smaller uses.

### BRIEF DESCRIPTION OF THE DRAWINGS

FIGS. 1A and 1B are perspective views of the present invention;

FIGS. 2A, 2B and 2C are perspective views of a second embodiment of the present invention;

FIG. 3 is a perspective view of a third embodiment of the present invention;

FIG. 4 is a perspective view of a fourth embodiment of the present invention;

FIG. 5 is a perspective view of a fifth embodiment of the present invention;

FIGS. 6A and 6B are perspective views a sixth embodiment of the present invention;

FIG. 7 is a perspective view of a seventh embodiment of the present invention;

FIG. 8 is a perspective view of an eighth embodiment of the present invention;

### DETAILED DESCRIPTION OF PREFERRED EMBODIMENTS

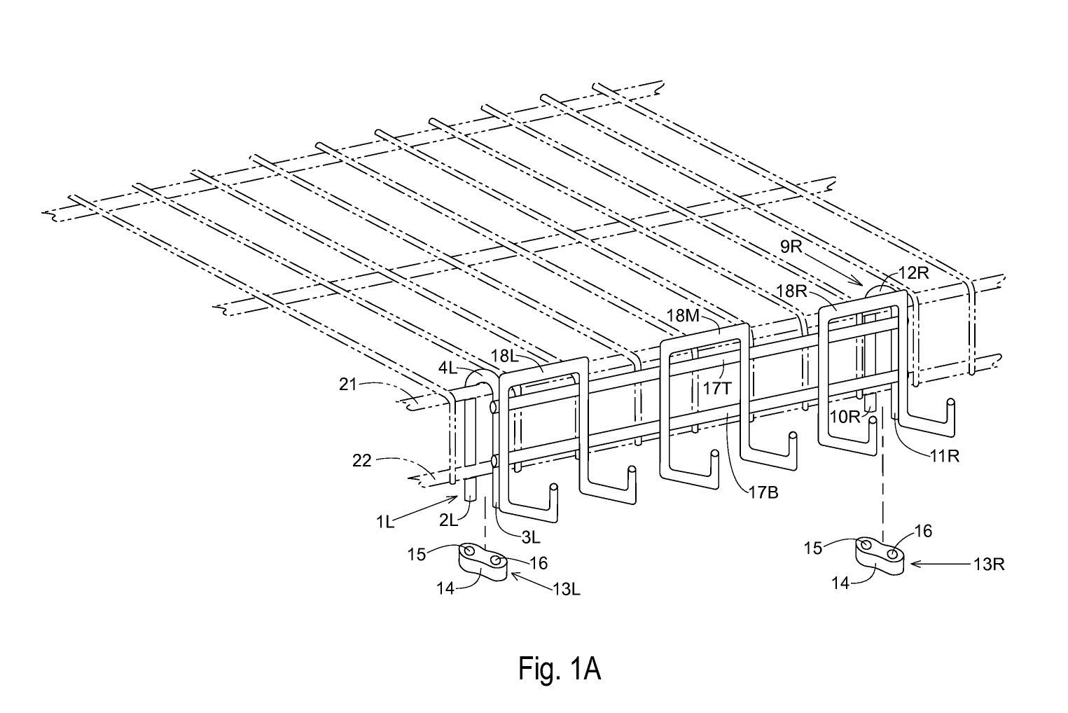

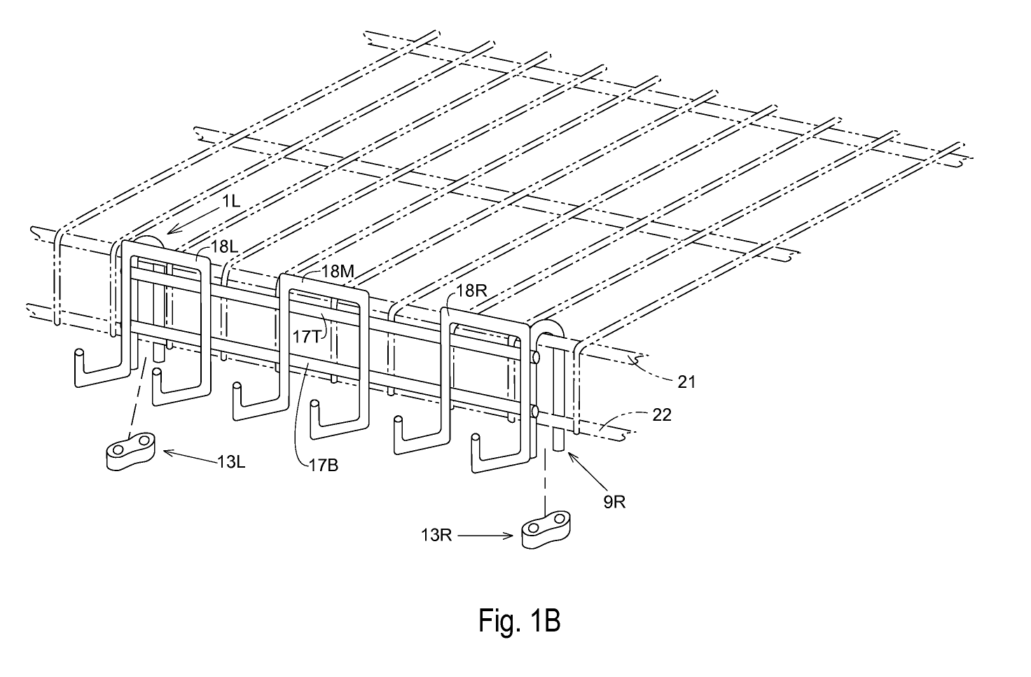

As shown in FIGS. 1A and 1B, the present invention comprises two metal hooks 1L, 9R, the tops of which 4L, 12R when mounted downwardly over the top of structure 21 come to rest onto and around the top 21 of a vertically-oriented unobstructed structure 21, 22 of corresponding depth, corresponding depth further described as the cross-sectional widths of 21 and 22 being approximately equal to the distance between 2L and 3L, 10R and 11R, and corresponding horizontal width along structure 21,22 and corresponding height in order to fit around a lower portion of the structure 22, and removably hold the bracket assembly where placed via gravity, two metal horizontal cross members 17T, 17B permanently attached to attachment hooks 1L, 9R perpendicularly, three common metal hooks 18L, 18M, 18R permanently attached upright and perpendicularly to horizontal cross members 17T, 17B, on the side opposite attachment hooks 1L, 9R. The bracket assembly further includes resilient elements 13L, 13R which are comprised of a resilient body 14 through which there are two vertical holes 15, 16 corresponding in size and offset to attachment hooks 1L, 9R, wherein the diameter of 2L, 3L, 10R, 11R is approximately equal to the diameter of holes 15, 16, and the distance between 2L and 3L, 10R and 11R is approximately equal to the distance between holes 15, 16, for removable attachment onto the ends 2L, 3L, 10R, 11R of attachment hooks 1L, 9R to prevent the bracket assembly from being accidentally dislodged when mounted.

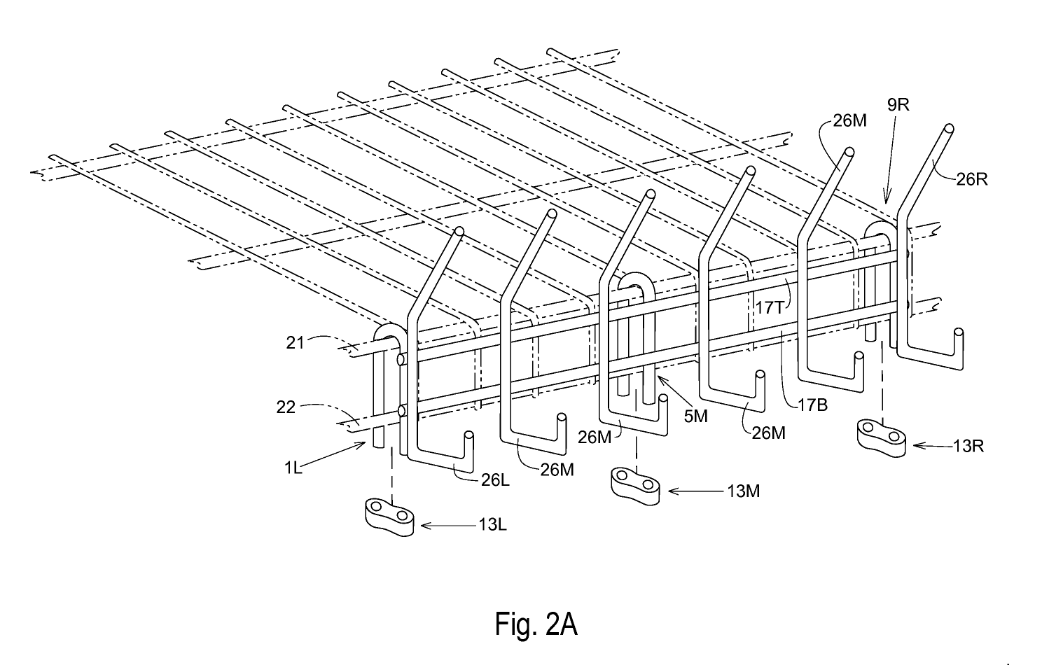

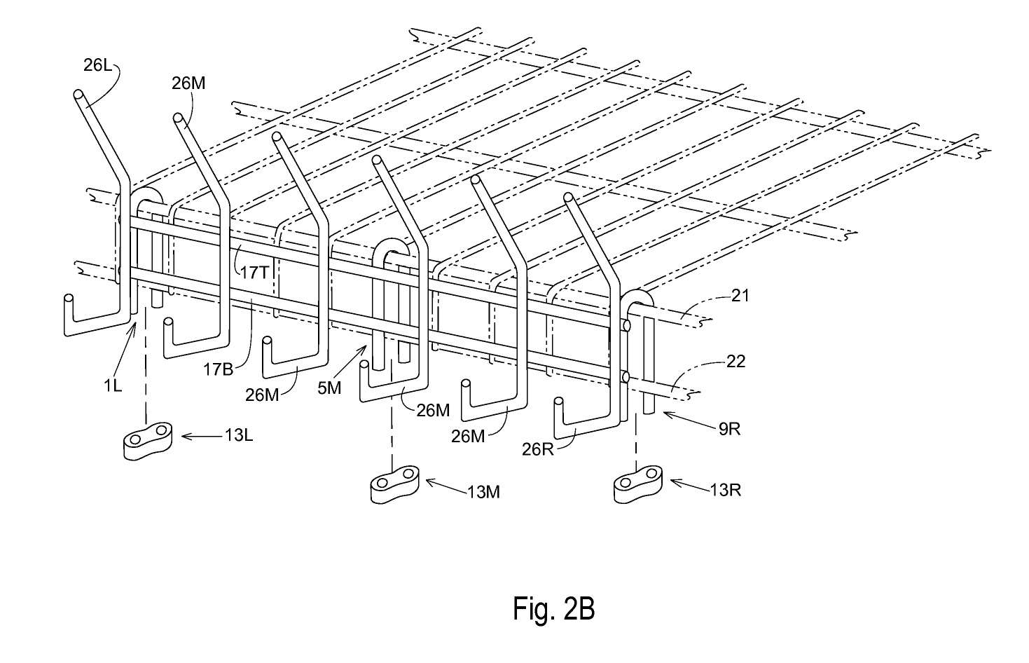

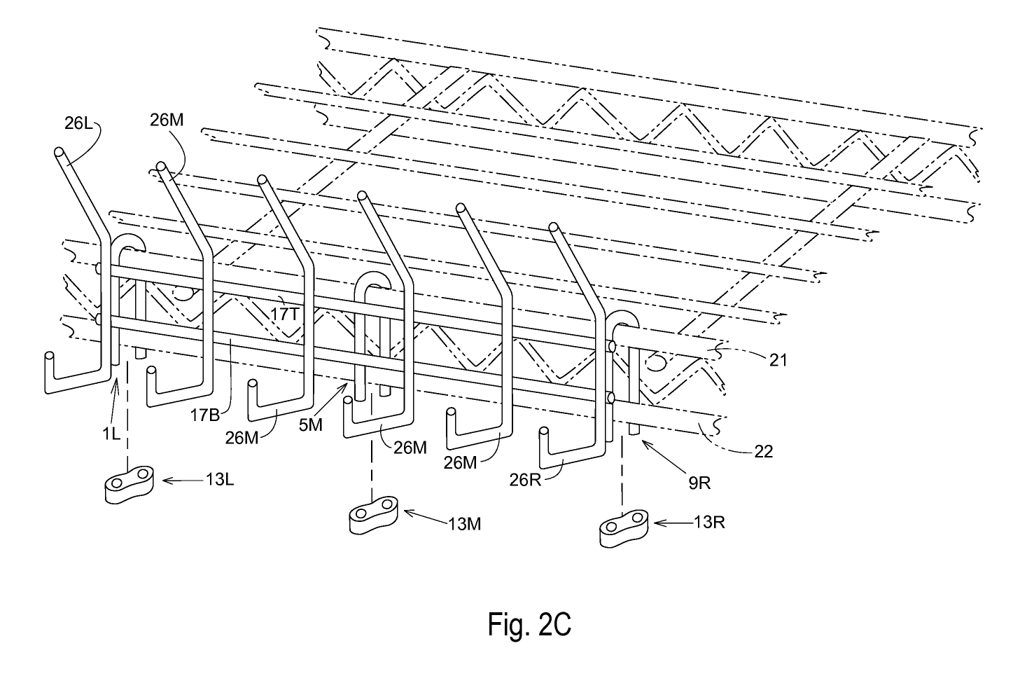

Referring to FIGS. 2A, 2B and 2C, the present invention comprises three metal hooks 1L, 5M, 9R, for removably attaching the bracket assembly onto and around a vertically-oriented unobstructed structure 21, 22 of corresponding depth, width and height, two metal horizontal cross members 17T, 17B permanently attached to attachment hooks 1L, 5M, 9R perpendicularly, six common metal hooks 26L, 26M, 26M, 26M, 26M, 26R permanently attached upright and perpendicularly to horizontal cross members 17T, 17B, on the side opposite attachment hooks 1L, 5M, 9R. The bracket assembly further includes resilient elements 13L, 13M, 13R for removable attachment onto the ends of the attachment hooks 1L, 5M, 9R to prevent the bracket assembly from being accidentally dislodged when mounted.

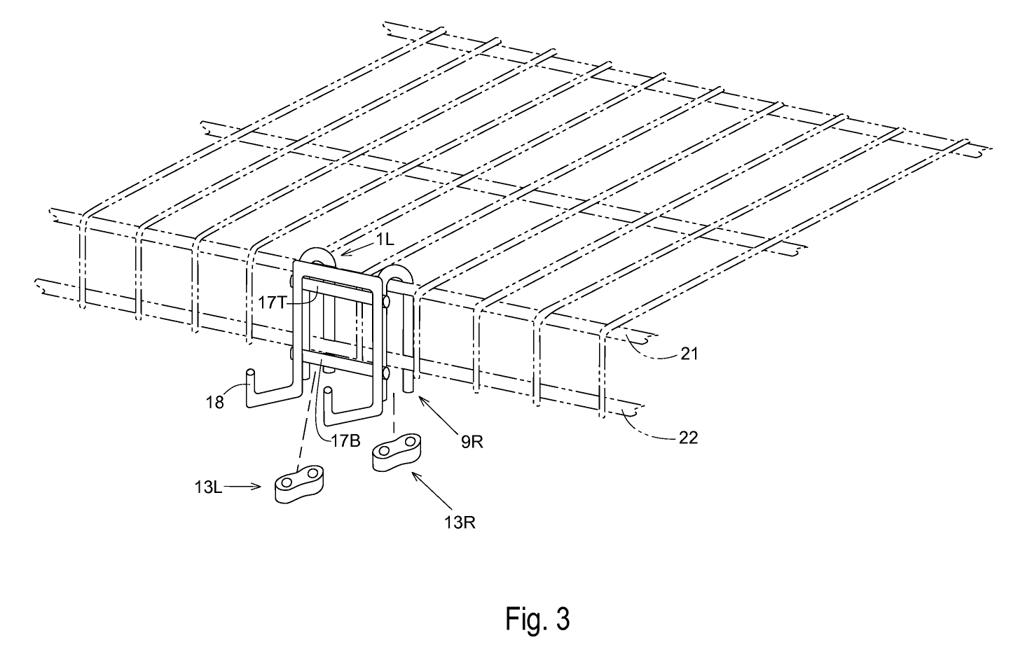

As shown in FIG. 3, the present invention comprises two metal hooks 1L, 9R, for removably attaching the bracket assembly onto and around a vertically-oriented unobstructed structure 21, 22 of corresponding depth, width and height, two metal horizontal cross members 17T, 17B permanently attached to attachment hooks 1L, 9R perpendicularly, one common metal hook 18 permanently attached upright and perpendicularly to horizontal cross members 17T, 17B, on the side opposite the attachment hooks 1L, 9R. The bracket assembly further includes resilient elements 13L, 13R for removable attachment onto the attachment hooks 1L, 9R to prevent the bracket assembly from being accidentally dislodged when mounted.

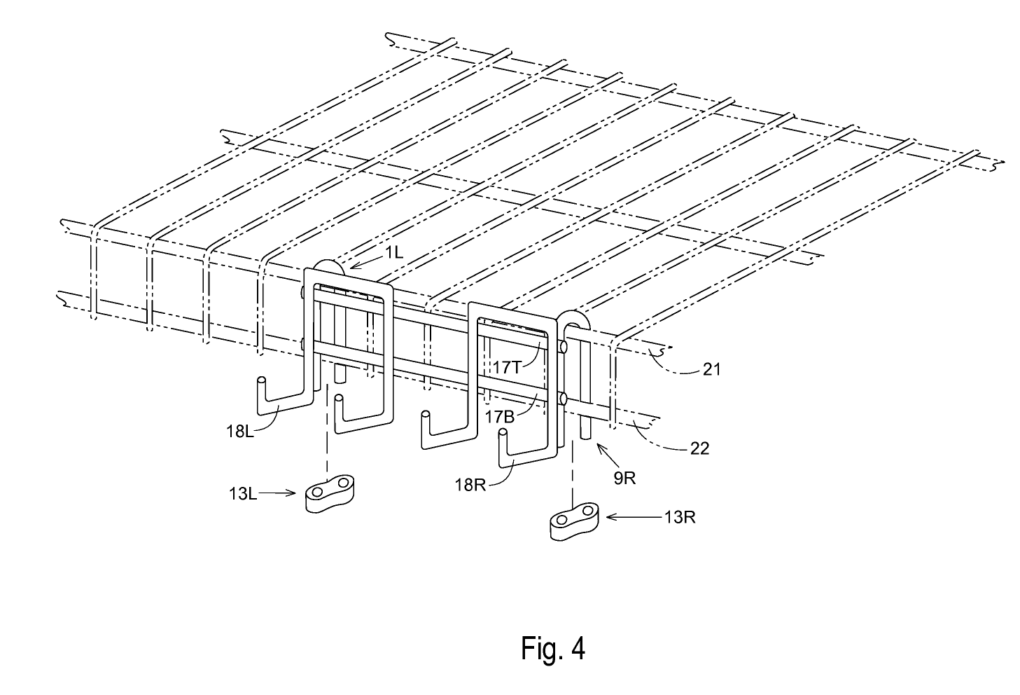

As shown in FIG. 4, the present invention comprises two metal hooks 1L, 9R, for removably attaching the bracket assembly onto and around a vertically-oriented unobstructed structure 21, 22 of corresponding depth, width and height, two metal horizontal cross members 17T, 17B permanently attached to attachment hooks 1L, 9R perpendicularly, two common metal hooks 18L, 18R permanently attached upright and perpendicularly to horizontal cross members 17T, 17B, on the side opposite attachment hooks 1L, 9R. The bracket assembly further includes resilient elements 13L, 13R for removable attachment onto the attachment hooks 1L, 9R to prevent the bracket assembly from being accidentally dislodged when mounted.

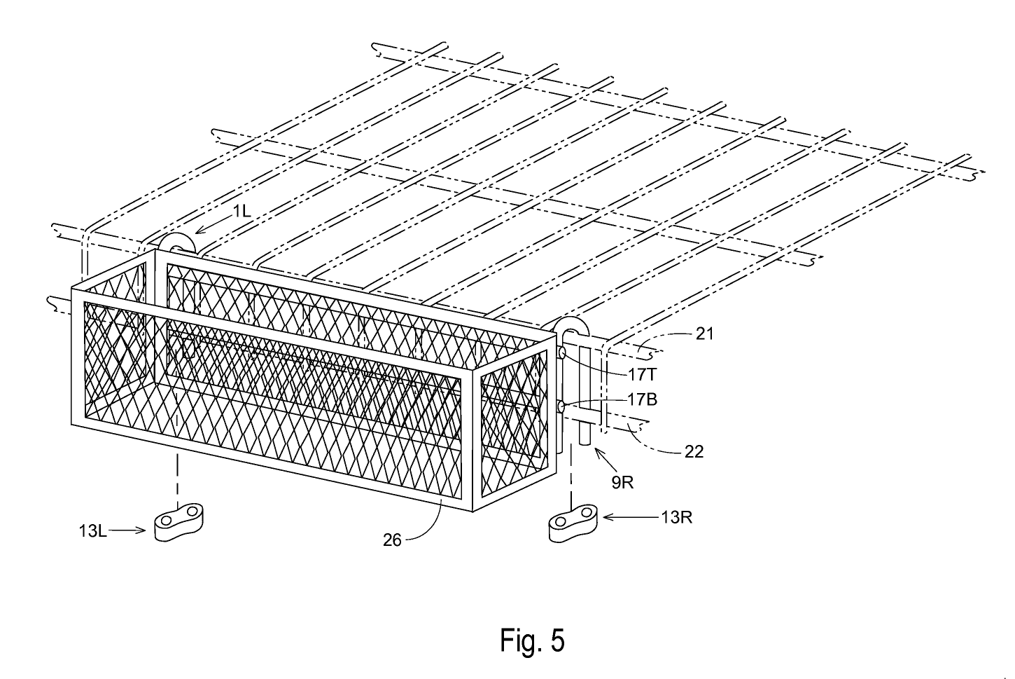

Referring to FIG. 5, the present invention comprises two metal hooks 1L, 9R, for removably attaching the bracket assembly onto and around a vertically-oriented unobstructed structure 21, 22 of corresponding depth, width and height, two metal horizontal cross members 17T, 17B permanently attached to attachment hooks 1L, 9R perpendicularly, one basket 26 permanently attached upright and perpendicularly to horizontal cross members 17T, 17B, on the side opposite the attachment hooks 1L, 9R. The bracket assembly further includes resilient elements 13L, 13R for removable attachment onto the attachment hooks 1L, 9R to prevent the bracket assembly from being accidentally dislodged in an upward direction when mounted.

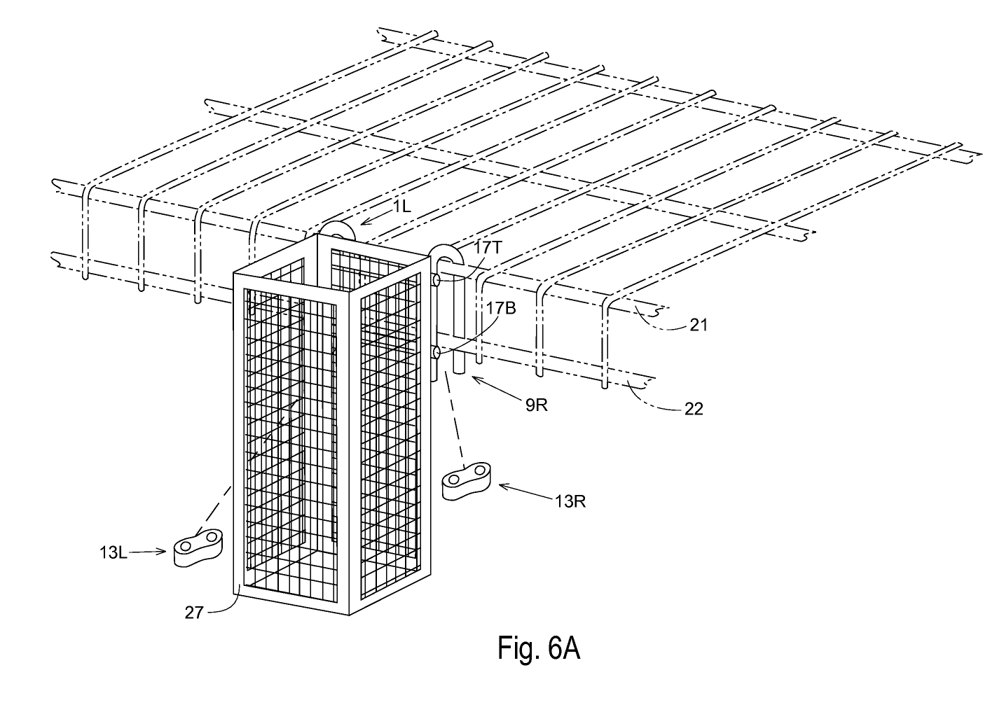

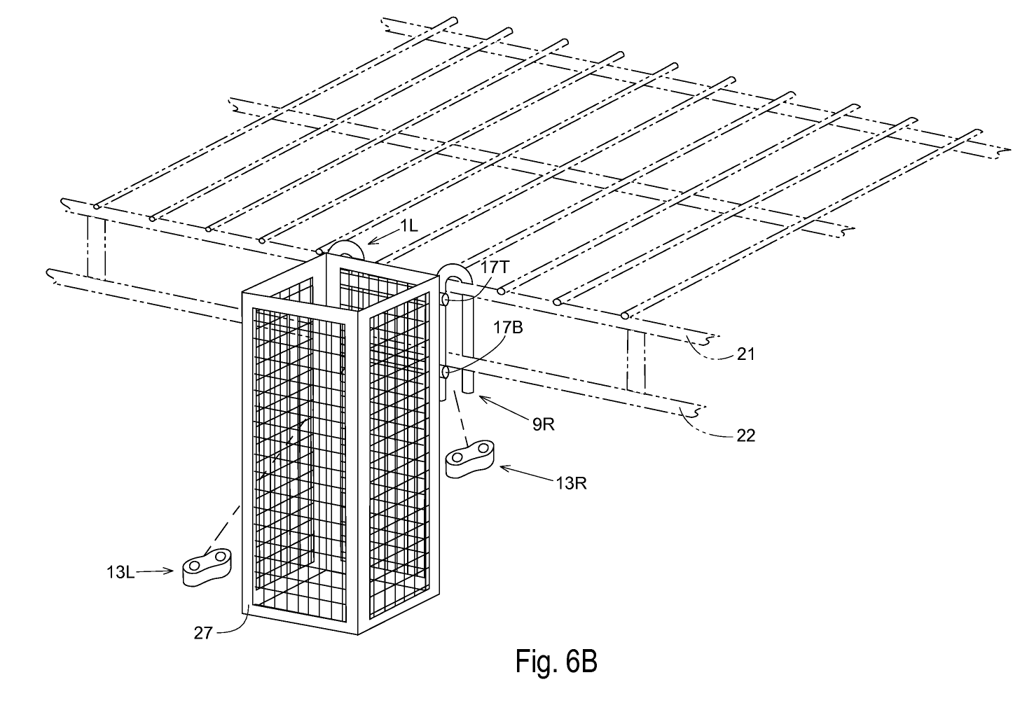

As shown in FIGS. 6A and 6B, the present invention comprises two metal hooks 1L, 9R, for removably attaching the bracket assembly onto and around a vertically-oriented unobstructed structure 21, 22 of corresponding depth, width and height, two metal horizontal cross members 17T, 17B permanently attached to attachment hooks 1L, 9R perpendicularly, one basket 27 permanently attached upright and perpendicularly to the horizontal cross members 17T, 17B, on the side opposite attachment hooks 1L, 9R. The bracket assembly further includes resilient elements 13L, 13R for removable attachment onto the attachment hooks 1L, 9R to prevent the bracket assembly from being accidentally dislodged when mounted.

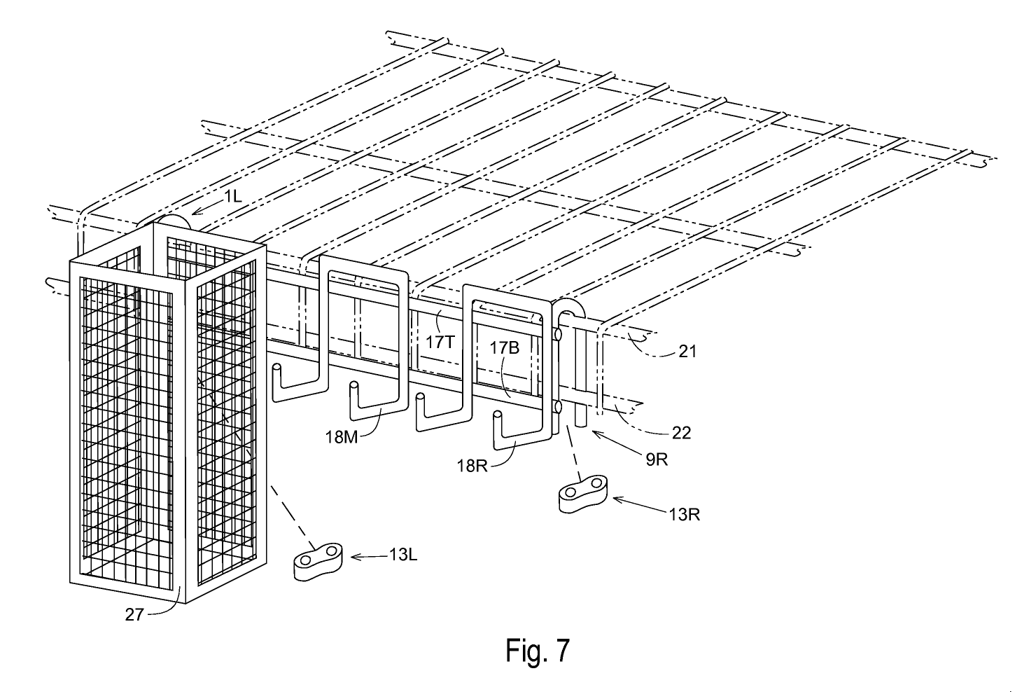

Referring to FIG. 7, the present invention comprises two metal hooks 1L, 9R, for removably attaching the bracket assembly onto and around a vertically-oriented unobstructed structure 21, 22 of corresponding depth, width and height, two metal horizontal cross members 17T, 17B permanently attached to attachment hooks 1L, 9R perpendicularly, one basket 27 and two hooks 18M, 18R permanently attached upright and perpendicularly to horizontal cross members 17T, 17B, on the side opposite the attachment hooks 1L, 9R. The bracket assembly further includes resilient elements 13L, 13R for removable attachment onto the attachment hooks 1L, 9R to prevent the bracket assembly from being accidentally dislodged when mounted.

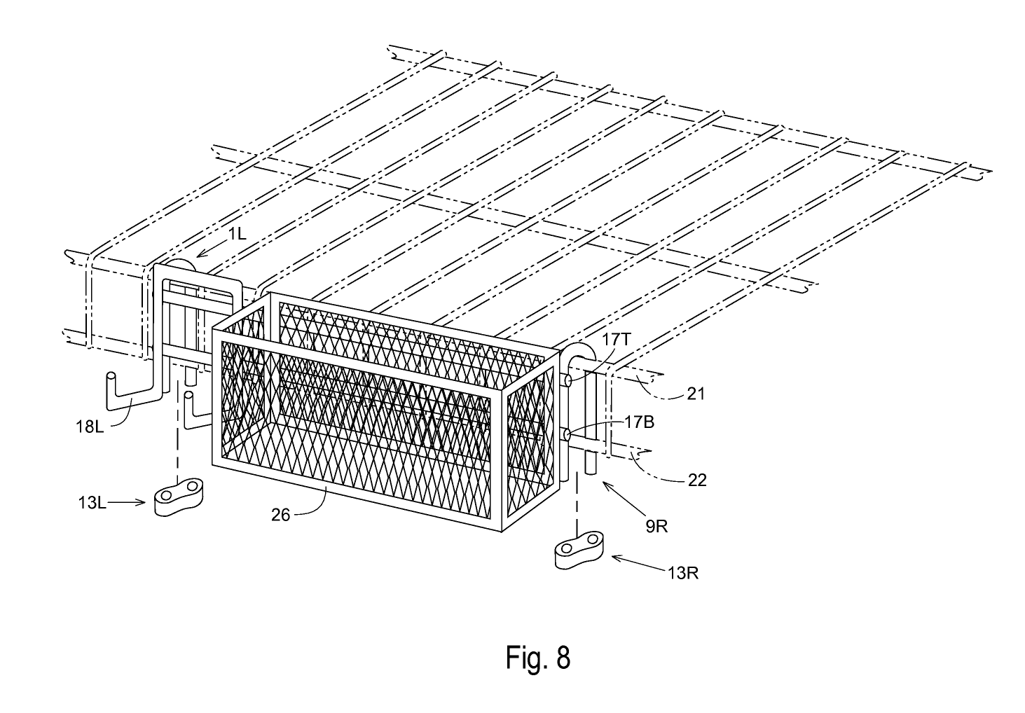

Referring to FIG. 8, the present invention comprises two metal hooks 1L, 9R, for removably attaching the bracket assembly onto and around a vertically-oriented unobstructed structure 21, 22 of corresponding depth, width and height, two metal horizontal cross members 17T, 17B permanently attached to attachment hooks 1L, 9R perpendicularly, one hook 18L and one basket 26 permanently attached upright and perpendicularly to the horizontal cross members 17T, 17B, on the side opposite attachment hooks 1L, 9R. The bracket assembly further includes resilient elements 13L, 13R for removable attachment onto the attachment hooks 1L, 9R to prevent the bracket assembly from being accidentally dislodged when mounted.

Having described preferred embodiments of the invention with reference to the accompanying drawings, it is to be understood that the invention is not limited to those precise embodiments. Numerous combinations of hooks and/or baskets and various changes and modifications could be effected by one skilled in the art without departing from the spirit or scope of the present invention, as defined in the appended claims.

What is claimed:

1. A metal hooked utility bracket assembly for removable yet secure mounting to a vertically-oriented structure of corresponding depth, width and height, comprising:
a plurality of metal hooks for removably mounting the bracket assembly downwardly onto, over and around a vertically-oriented unobstructed structure of corresponding depth, width and height;
a metal horizontal cross member or plurality thereof permanently attached to the attachment hooks perpendicularly for creating the frame of the bracket assembly;
any number of common metal hook(s) and or basket(s) or any combination thereof permanently attached to the horizontal cross member(s), on the side opposite the attachment hooks, for the receipt of items.

2. A metal hooked utility bracket assembly according to claim 1, wherein the bracket assembly further includes resilient element(s) for removable attachment onto the ends of the attachment hooks to secure the bracket assembly from being accidentally dislodged when mounted.
